(19) United States
(12) Patent Application Publication
(10) Pub. No.: US 2017/0363267 A1
(43) Pub. Date: Dec. 21, 2017

(54) LIGHTING AND/OR SIGNALLING DEVICE INCLUDING A LIGHTGUIDE

(71) Applicant: VALEO VISION, Bobigny Cedex (FR)

(72) Inventors: Michael MAITRE, Bobigny Cedex (FR); Marc THABOUREY, Bobigny Cedex (FR); Fabien SERGENT, Bobigny Cedex (FR)

(73) Assignee: VALEO VISION, Bobigny Cedex (FR)

(21) Appl. No.: 15/536,721

(22) PCT Filed: Dec. 18, 2015
(86) PCT No.: PCT/EP2015/080554

§ 371 Date: Jun. 16, 2017

(30) Foreign Application Priority Data
Dec. 19, 2014 (FR) 1462953

(51) Int. Cl. F21S 8/10; F21V 19/00; F21V 8/00

(52) U.S. Cl. CPC F21S 48/2206; G02B 6/0008; G02B 6/0006; F21V 19/0015; F21S 48/2293; F21S 48/2287; F21S 48/1109; F21S 48/215; F21S 48/212; F21S 48/1241; F21S 48/1208; F21S 48/115; F21S 48/2237

(57) ABSTRACT

The invention relates to a lighting and/or signaling device including an electroluminescent diode and a lightguide adapted to convey the light from the diode and also means for securing the diode relative to an end of the lightguide to ensure the position of an inlet face of the guide opposite the diode. The lightguide carries male securing means adapted to interact with female securing means carried by a plastics component carrying the electroluminescent diode. The plastics component further includes electric circuits produced directly on the plastics of this component in immediate proximity to the diode.

The present invention relates to a lighting and/or signaling device comprising an electroluminescent diode and a lightguide adapted to convey the light from the diode. It relates more particularly to means for securing the diode relative to the lightguide.

The invention is particularly of use in motor vehicle headlights or lamps, in which the use of electroluminescent didoes is becoming increasingly common. Motor vehicle lighting modules are thus known which comprise a housing secured to the vehicle structure and closed by a headlight outer lens, a signaling and/or lighting device based on electroluminescent diodes being housed inside the module.

This type of signaling and/or lighting device comprises an optical guide arranged opposite the electroluminescent diodes to achieve the desired guiding of the light. Means for securing the lightguide relative to the electroluminescent diode are to be provided in order that, on the one hand, the required distance between these two components is complied with and that, on the other, the diode is correctly centered relative to the inlet face of the lightguide. In point of fact, it is appropriate for all the rays emitted by the electroluminescent diode should enter the lightguide by refraction in such a manner as to limit the loss of efficiency of lighting and to avoid the over-sizing of the diodes in order to obtain the desired photometric performance level.

Patent documents WO 12098123 and EP 2 479 487 disclose tubular light tubes at the end of which is secured an electroluminescent diode in such a manner that all the light rays from the diode enter by refraction into the lightguide as far as an outlet face determined in order that the rays exit the headlight in accordance with the desired tilt. These documents disclose embodiments in which the tubular lightguide is attached onto a support component having, on the one hand, means for receiving the guide and, on the other, means for receiving a printed circuit board on which are arranged, at one and the same time, an electroluminescent diode and electronic circuits adapted to power the electroluminescent diode with current. The stacking of these three components engenders bulkiness, which may be detrimental in a zone where, for reasons of esthetics or reasons of regulations, the notion of compactness is important.

In this context, the present invention proposes a lighting and/or signaling device such as described previously, in which the securing of the lightguide relative to the position of the electroluminescent diode is optimized.

The invention proposes a device comprising an electroluminescent diode and a lightguide adapted to convey the light from said diode and also means for securing the diode relative to an end of the lightguide to ensure the position of an inlet face of the guide opposite the diode, characterized in that the lightguide carries male securing means adapted to interact with female securing means carried by a plastics component carrying the electroluminescent diode and electric circuits provided directly on said plastics component in immediate proximity to the diode. Thus, particularly by producing a molded interconnect device (MID), it is possible to incorporate the electric circuits directly into the plastics component that also carries female means for interacting with a male endpiece integral with the lightguide. The plastics component thus does not carry the diode and its power circuits on a rigid or flexible printed circuit board, but directly on its surface. Advantageously, the electroluminescent diode is thus of the diode on base or “submount” type. It is possible to observe that the number of components for installing the lightguide opposite the diode is in fact reduced, which cuts down the sequences of gradients and makes it possible to prevent a corresponding dispersion of the light stream. It is thus unnecessary to over-size the diode in order to compensate for this dispersion. In the case of production of the device using a specific MID technique, known as “hot embossing”, provision is made for the plastics component to carry the diode and the corrective tracks in a planar central part.

Advantageously, the presence of an intermediate component has been replaced by a modified lightguide and a modified assembly of electric circuits without, however, complicating the design and manufacture of the lightguide, since only one male part, for positioning in the female part of the clip, is required projecting from the guide. This ensures the function of positioning, without being detrimental to the optical performance level of the lightguide and without complicating its manufacture, the difficult demolding of the components of the prior art potentially adversely affecting their optical function.

According to different secondary characteristics of the invention:

the male part of the securing means is provided by a plate arranged at the end of the lightguide and laterally projecting beyond said guide for forming protuberant means adapted to interact with said female securing means carried by the plastics component. The plate is provided in a transparent material capable of guiding the light rays from the electroluminescent diode. Advantageously, this plate forming the male part of the securing means is made of a single piece with the lightguide;

the plate forming the male part of the securing means has a variable thickness, particularly because the thickness is diminished at the center of this plate, in line with the lightguide and the diode. Thus, it is ensured that the light emitted by the diode traverses a minimum of material prior to entering the tubular portion of the lightguide and that there is as little impact as possible on the trajectory of the light beam. The male part may advantageously incorporate a Fresnel lens type collimation structure;

the plastics component for supporting the diode has a planar central part for receiving the diode and electric circuits and also peripheral parts which extend as projections around said planar central part and which form said female securing means;

the plastics component for supporting the diode is obtained by hot embossing, incorporating into the plastics a metal sheet on which are provided electric circuits for powering and controlling the electroluminescent diode. Advantageously, by means of this production technique, there is a greater increased thickness of metal centered around the electroluminescent diode;

the support component may also incorporate the function of connector, either by means of a card edge connector technique, or with any type of force-inserted connector, with the electric contacts of the connector electrically connected, by means of a conducting adhesive or a brazing paste, for example, to the electric circuits provided on the plastics of said support component;

the plastics component for supporting the diode is made from conducting polymer material, that is to say with a conductivity in excess of 1 W·m⁻·k⁻¹. By way of example, the material may be a polyamide, polypropylene or polystyrene, with thermally conducting fiber filler;

the plastics support component may comprise a through-hole capable of receiving a diode mounted in such a manner that the securing elements and connection of the diode are added against a face of the support component opposite the direction of emission of the light rays exiting the diode;

the electric circuits may be coated with a varnish, in order to protect them.

The invention also relates to a motor vehicle comprising a lighting and/or signaling module, in which at least one lightguide and one electroluminescent diode are housed for the emission and the guiding of light, characterized in that the guide and the diode are secured to one another in a device as described above. According to different characteristics, the female part of the securing means is embodied by a plastics component that is attached to the module or, alternatively, this female part is provided directly on the housing of a lighting and/or signaling module of a motor vehicle.

The invention and the ensuing advantages will be detailed in the following detailed, non-limiting description, which will be given in relation to the appended drawings, in which:

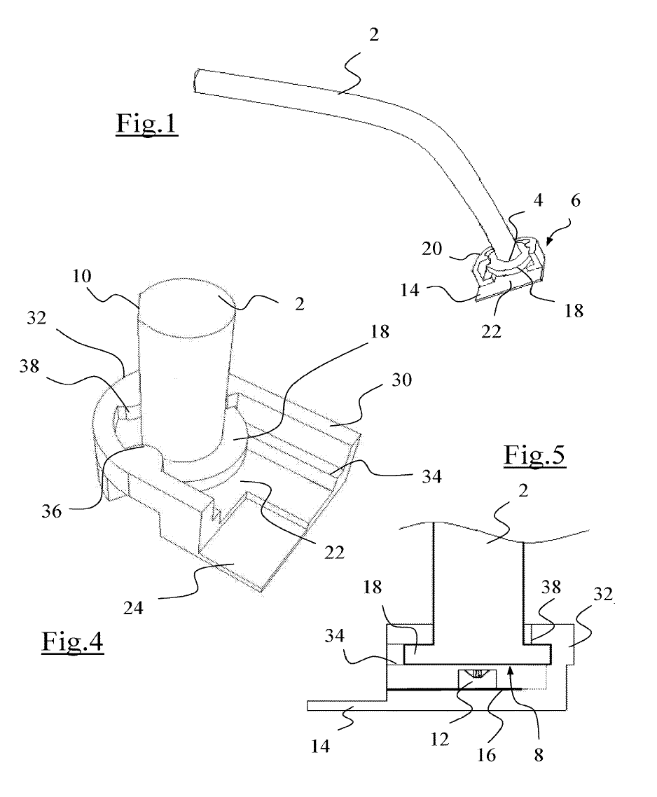

FIG. 1 is a perspective view of a lighting and/or signaling device according to the invention, comprising, in particular, a tubular lightguide and securing means for an electroluminescent diode arranged at an end of this guide;

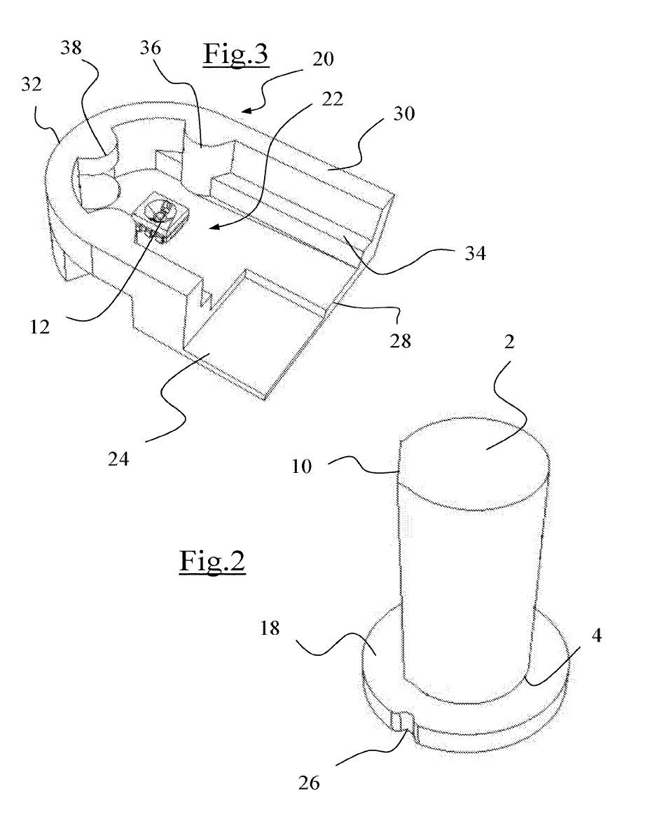

FIGS. 2 and 3 are perspective views of male and female components of the device illustrated in FIG. 1, according to a first embodiment of the invention;

FIGS. 4 and 5 are views in perspective and in section from the side of the assembly of the two components illustrated in FIGS. 2 and 3; and

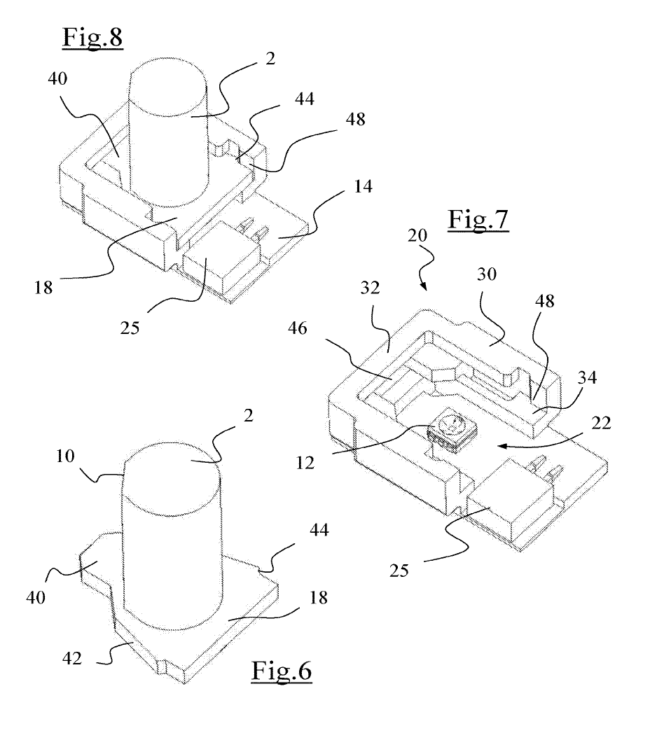

FIGS. 6, 7 and 8 are views similar to FIGS. 2, 3 and 4 for a second embodiment of the invention.

As illustrated in FIG. 1, the lighting and/or signaling device comprises a tubular lightguide 2, at a proximal end 4 of which are means 6 for securing a light source.

This device is particularly suited for placing in the housing of a lighting and/or signaling module of a motor vehicle, the light emitted by the light source being received and conveyed by the lightguide from an inlet face 8 opposite the source to an exit face formed by a surface of revolution of the tubular guide. As is known, furthermore, the guide comprises a face 10 reflecting the rays conveyed in the guide, comprising, for example, prisms that send the rays back toward the exit face at an incident angle permitting their refraction outside the guide and outside the module in order to achieve the desired lighting and/or signaling function.

The light source is formed by an electroluminescent diode 12 carried by a plastics component 14 also carrying electric circuits 16 for powering and controlling the diode, represented, by way of example, by a thick line in FIG. 5, and possibly coated with a varnish for protection.

The support component 14 and the guide 2 are adapted to interact in order to ensure the relative position of the diode relative to the inlet face of the lightguide. More precisely, they each have forms adapted to achieve, on the one hand, the guiding in position of the guide in the plastics component as far as an active position in which the inlet face of the guide is located in line with the diode and to achieve, on the other, the immobilization of the guide in this active position.

According to the invention, the lightguide has male securing means adapted to interact with corresponding female securing means carried by the plastics component for supporting the diode, such that it is the guide which is inserted and immobilized in position in the plastics component.

The lightguide 2 has, at its proximal end 4, a plate 18 extending, as a transverse projection, the tubular portion of the guide. The guide extends along a predetermined curved axis XX′ and the plate extends transversely in this predetermined direction.

The guide and the plate are produced as a single component, from transparent polymer of the polycarbonate (PC) or poly(methyl methacrylate) (PMMA) type, or from any other suitable polymer, that is to say in a transparent material that can be traversed by the light rays emitted by the diode. The plate extends as a lateral projection beyond the guide and thus forms protuberant means that will be described in detail below as the male securing means in the description of two embodiments.

Generally, the corresponding female securing means are carried by the plastics component and peripheral parts 20 of this plastics component, which rise as projections on either side of a planar central part 22 that carries the diode 12 and the electric circuits 16 centered around the diode. The plastics support component further comprises a casing 24 adapted to receive, at least in part, a connector 25, visible in FIGS. 7 and 8, which is connected to the electric circuit provided in the plastics of the support component.

The particular method according to the invention for producing the plastics component will be described below, and in particular the hot-embossing technique used in order directly to embed the electric circuits in the plastics thickness of the support component.

A description will now be given, with reference to FIGS. 2 to 5, of a first embodiment of the means for securing the lightguide relative to the electroluminescent diode.

As illustrated in FIG. 2, the plate forms a collar at the end of the lightguide. The collar has a larger diameter than the diameter of the tube such that, as described previously, the plate extends as a lateral projection beyond the tube. Two notches 26 are arranged diametrically opposed on the circular periphery of this plate.

As illustrated in FIG. 3, the component for supporting the diode has the form of a housing 28 with a bottom wall comprising the planar central part 22 and peripheral parts 20 that rise as projections around this bottom wall.

The peripheral parts comprise two lateral longitudinal walls 30 that for the guide plate form transverse abutments and thus longitudinally guide the insertion of the plate, and also a transverse end wall 32. Opposite this transverse wall, the absence of peripheral parts allows the insertion of the plate into the support component.

The longitudinal walls have a section that varies between the thicker base and the thinner free end opposite the bottom wall. The thicknesses are determined such that the distance between the bases of the longitudinal walls is smaller than the diameter of the plate at the end of the guide, preventing the insertion of the lightguide at this level. Upon insertion of the guide, this prevents a collision with the diode. The guide is inserted higher up and the shoulder of the longitudinal walls forms a vertical guide edge 34 on which the plate at the end of the guide is able to rest while bearing. It will be observed that the lateral walls and the shoulder form a guide path for this plate.

Two uprights 36 extend as projections beyond the lateral walls, toward the interior of the component for supporting the diode, in such a manner as to narrow the passage for the plate. The user has to apply force to the plate upon insertion in order to allow passage of the plate by deforming the plastics component by moving the lateral walls further apart. The lightguide is in the active position when the lateral uprights penetrate the notches formed in the plate. It will be understood that, in order that the user does not go beyond this active position upon force-insertion of the guide, the plate enters into abutment against the transverse end wall.

This transverse end wall comprises, substantially at its center, a vertical abutment means 38 extending as a projection beyond the wall toward the interior of the support component and arranged at a distance from the bottom wall that is slightly greater than the addition of the height of the shoulder relative to the bottom wall and the thickness of the plate extending the lightguide. Thus, when the guide is inserted into the housing by sliding of the plate against the shoulders of the lateral walls, it is located in its active position housed under this vertical abutment means. The plate, and the associated guide, are thus immobilized in position, first in the plane of the bottom wall by means of the interaction of the uprights of the support component and the notches of the plate, and, second, in the third dimension, perpendicular to the bottom wall by means of the immobilization of the plate between, on the one hand, the abutment means carried by the end wall and, on the other, the shoulders of the lateral walls.

A description will now be given of a second embodiment illustrated in FIGS. 6 to 8. The lighting and/or signaling device according to this second embodiment has a structure similar to that of the device described previously. In accordance with that which has been specified generally for the invention, and taking again the numerical references used for the description of the first embodiment, the lightguide 2 has, at its end, a plate 18 forming male securing means adapted to interact with female securing means carried by a plastics component 14 for supporting the diode, on which electrical circuits for powering and controlling the diode are provided, in this case, by way of non-limiting example, at the level of a planar central part of the component 22. However, the devices differ in terms of structural details, such as the form of the plate and the form of the support component.

As illustrated in FIG. 6, the plate has a trapezoidal form arranged at the end of the lightguide. The small base of the trapezium forms a tenon 40 pointing toward the exterior of the guide. The lateral walls 42, connecting the bases of the trapezium, are machined close to the large base in order to form abutment walls 44 when the guide is in position in the component for supporting the diode.

As illustrated in FIG. 7, it will be noted that the component for supporting the diode also has the form of a housing 28 with peripheral parts including two lateral longitudinal walls 30 and a transverse end wall 32.

The transverse end wall comprises a central opening 46 of a form adapted to allow passage of the tenon of the plate extending the lightguide. There is thus tenon/mortise type interaction, which allows the mounting of the guide in the component for supporting the diode with poka-yoke means allowing guaranteed satisfactory orientation of the exit face 10 of the lightguide. The edges of the wall delimiting the central opening form vertical stop means for preventing the disengagement of the plate relative to the component perpendicularly to the plane defined by the bottom wall. In the direction of insertion of the plate in the support component, abutment means specific to this embodiment are provided to define the active position of the lightguide. In the insertion direction, the plate abuts against the transverse end wall. In the opposite direction, the abutment walls 44 formed on the lateral walls of the plate interact with shoulders 48 arranged at the free end of the lateral longitudinal walls. As previously, the user has to apply force to the plate upon insertion in order to allow passage of the plate, by deforming the plastics component by means of the lateral walls moving further apart. The light guide is in the active position when the lateral walls of the plate have passed beyond the shoulders arranged at the free end of the lateral longitudinal walls.

It will be noted, in FIGS. 4 and 8 according to the embodiment, that, when the lightguide and the plastics component are assembled such that the guide is in its active position, the position of the lightguide opposite the electroluminescent diode has been ensured using a minimum of components. The dimension of the axial stacking of these components, in accordance with the mechanical axis of the diode, is minimal, defined principally by the thickness of the bottom wall carrying the electroluminescent diode and by the thickness of the plate extending the lightguide.

It will be understood that it is possible, without departing from the context of the invention, to make provision for other forms of the plate extending the lightguide and of the housing receiving this plate, provided that the lightguide carries male securing means adapted to interact with female securing means carried by a plastics component carrying the electroluminescent diode and the electric circuits produced directly on the plastics of the components for supporting the guide.

For example, in a variant embodiment that is not shown, the thickness of this plate is variable, particularly in that a smaller thickness is provided in the direct extension of the tubular guide. When the lightguide in in the active position, this smaller thickness is in line with the diode such that the light rays from the diode having to enter the tubular guide by refraction have a smaller thickness of transparent material to traverse.

Likewise, provision may also be made to produce the plastics component for supporting the diode either by means of a housing that is then secured on the lighting and/or signaling modules (as is the case in the embodiments illustrated in the figures), or directly in the thickness of the housing forming the lighting and/or signaling module in which the device according to the invention is installed.

A further variant embodiment consists in a specific arrangement of the diode, mounted in accordance with an “LED reverse” technique, in which the support plate carrying the electric circuits has a hole allowing the positioning of the diode through this hole, the dome of the diode being oriented on the side of a first face of the support plate while the electric contacts of the diode are arranged on the side of the opposite face of the support plate, this opposite face carrying the conducting tracks to be connected to the diode.

A description will now be given of the method for producing the plastics component, in which electric circuits are injected, in order to form a molded interconnect device (MID). In this case, it is a particular method, in which use is made of a “hot-embossing” technique.

The hot-embossing technique used here consists in producing a metal sheet, depositing this sheet on that part of the support component that is designed to carry the conducting tracks, optionally with a heat-activated adhesive placed between the sheet and the support component, and a hot-embossing step of the plastics component in order to apply the sheet thereon.

A preliminary step consists in giving the sheet the desired thickness of metal and possibly variable thicknesses.

When this sheet is deposited on the support, a hot press is applied to the sheet under temperature conditions suited to the plastic deformation of the material of the support component. The face of the press brought to enter into contact with the metal sheet comprises ribs extending as projections from this face in accordance with an arrangement corresponding to the arrangement of the conducting tracks which are desired to be incorporated onto the support plate. Hot deformation of the support plate gives rise to the formation of housings of a form complementing those of the ribs projecting from the press. The metallic layers are pushed into these housings and the metal incorporated into the volume of the support plate forms conducting tracks.

The choice of hot embossing makes it possible to deposit a thick layer of metal in the planar part of the female component. “Thick” is understood to mean a thickness in excess of 20 microns, preferably between 20 and 200 microns. This is particularly advantageous in the case where, as occurs frequently in the automobile industry, for example, provision is made for a high-power diode and thus demanding thermal management of the diode and greater dissipation of heat, Advantageously, by virtue of this hot embossing technique, it is possible easily to center the extra thickness of metal around the diode.

As just described, the device according to the invention applies particularly in a lighting and/or signaling module of a motor vehicle. It may alternatively be installed in the vehicle either for interior or for exterior lighting. This device offers the advantage of an assembly of the guide and of the diode support in which a male securing part is carried by the guide such that it is easier to obtain by molding than if it were to carry female parts, which are difficult to extrude. In this context, the support component is advantageously a molded interconnect device, so as to render possible the double function of the support component, i.e. support for the electric circuits and support for the diode.

This thus ensures the position of the lightguide relative to the diode in such a manner as to inject a maximum of light into the guide, using fewer components than in the prior art and components that are simple to obtain by molding. An optical module may thus be proposed of which the dimensions are controlled and in which there is no need to over-dimension the diode in order to obtain the amount of light emitted.

1. A lighting and/or signaling device comprising an electroluminescent diode and a lightguide adapted to convey the light from said diode and also means for securing the diode relative to an end of the lightguide to ensure the position of an inlet face of the guide opposite the diode, wherein the lightguide carries male securing means adapted to interact with female securing means carried by a plastics component carrying the electroluminescent diode and electric circuits provided directly on said plastics component in immediate proximity to the diode.

2. The device according to claim 1, characterized in that wherein the male part of the securing means is provided by a plate arranged at an end of the lightguide and laterally projecting beyond said guide for forming protuberant means adapted to interact with said female securing means carried by the plastics component, said plate being provided in a transparent material capable of guiding the light rays from the electroluminescent diode.

3. The device as claimed in according to claim 2, characterized in that wherein the plate forming the male part of the securing means is made as a single piece with the lightguide.

4. The device according to claim 2, wherein the plate forming the male part of the securing means has a variable thickness, particularly because the thickness is diminished at the center of this plate, in line with the lightguide and the electroluminescent diode.

5. The device according to claim 1, wherein the plastics component for supporting the diode has a planar central part for receiving the diode and electric circuits and also peripheral parts which extend as projections around said planar central part and which form said female securing means.

6. The device according to claim 5, wherein the plastics component for supporting the diode is obtained by hot embossing, incorporating into the plastics a layer of metal of which the arrangement forms the electric circuits for powering and controlling the electroluminescent diode.

7. The device according to claim 6, wherein the thickness of the layer of metal incorporated into the plastics is greater around the electroluminescent diode.

8. The device according to claim 1, wherein the plastics support component also carries a connector connected to said electric circuits incorporated into the plastics of said support component.

9. The device according to claim 1, wherein the plastics component for supporting the diode is made from conducting polymer material.

10. The device according to claim 1, wherein the plastics support component may comprise a through-hole capable of receiving a diode mounted in such a manner that the securing elements and connection of the diode are added against a face of the support component opposite the direction of emission of the light rays exiting the diode, said face serving for the securing of the diode further carrying the electric circuits.

11. The device as claimed in according to claim 1, wherein the electric circuits are coated with a varnish.

12. A motor vehicle comprising a lighting and/or signaling module, in which at least one lightguide and one electroluminescent diode are housed for the emission and the guiding of light, wherein the guide and the diode are secured to one another in a device according to claim 1, the plastics component forming the female securing means being formed by a housing attached on a wall of said module.

13. A motor vehicle comprising a lighting and/or signaling module, wherein at least one lightguide and one electroluminescent diode are housed for the emission and the guiding of light, wherein the guide and the diode are secured to one another in a device according to claim 1, the female securing means being directly formed on a plastics wall of said module.

14. The device according to claim 3 wherein the plate forming the male part of the securing means has a variable thickness, particularly because the thickness is diminished at the center of this plate, in line with the lightguide and the electroluminescent diode.

15. The device according to claim 2, wherein the plastics component for supporting the diode has a planar central part for receiving the diode and electric circuits and also peripheral parts which extend as projections around said planar central part and which form said female securing means.

16. The device according to claim 2, wherein the plastics support component also carries a connector connected to said electric circuits incorporated into the plastics of said support component.

17. The device according to claim 2, wherein the plastics component for supporting the diode is made from conducting polymer material.

18. The device according to claim 2, wherein the plastics support component may comprise a through-hole capable of receiving a diode mounted in such a manner that the securing elements and connection of the diode are added against a face of the support component opposite the direction of emission of the light rays exiting the diode, said face serving for the securing of the diode further carrying the electric circuits.

19. The device according to claim 2, wherein the electric circuits are coated with a varnish.

20. A motor vehicle comprising a lighting and/or signaling module, in which at least one lightguide and one electroluminescent diode are housed for the emission and the guiding of light, wherein the guide and the diode are secured to one another in a device according to claim 2, the plastics component forming the female securing means being formed by a housing attached on a wall of said module.
